(19) United States
(12) Patent Application Publication
(10) Pub. No.: US 2012/0320484 A1
(43) Pub. Date: Dec. 20, 2012

(54) Fire Sentry

(76) Inventor: Benjamin Henry Seigler, Sevierville, TN (US)

(21) Appl. No.: 13/164,299

(22) Filed: Jun. 20, 2011

(51) Int. Cl. H02H 1/00

(52) U.S. Cl. 361/114

(57) ABSTRACT

The Fire Sentry is a unique Fire Prevention Device. This Device will disengage the Electrical Power to the Cooking Appliance in which it is connected to. This Device will detect Black Smoke from a Stove or other Cooking appliance before it has the chance to combust and create a Fire. Once the Black Smoke has been removed from the Fire Sentry's Sensors the unit can be reset and normal cooking/heating can be resumed.

Incorporate a Smoke Detectors signal circuitry to remove Electrical power to a Cooking appliance such as a Stove. This will prevent most fires from occurring due to overcooking on a stove. Can be used for any conventional stove.

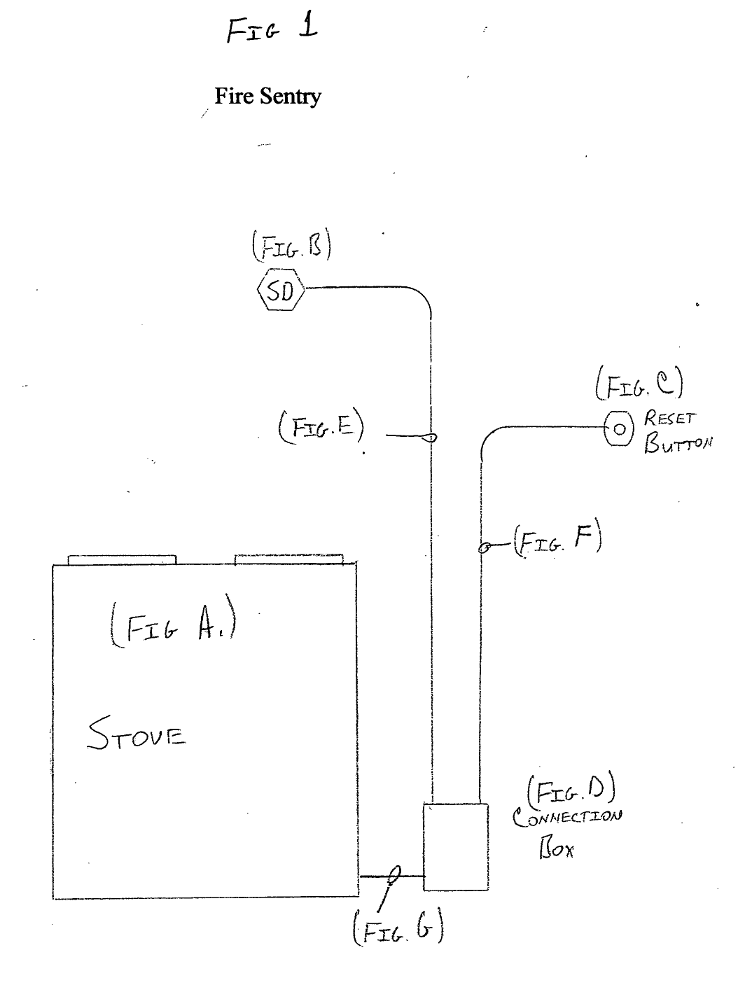

FIG. 1

(FIG. A) Represents any appliance or cooking device that you want to connect the Fire Sentry to.

(FIG. B) Smoke detection embodiment that detects black smoke that occurs just before a fire.

(FIG. C) Reset button or switch. To reset the embodiment once the trouble has been cleared.

(FIG. D) Connection box. Plugs into wall outlet the serves the device to be protected and the device is plugged into the connection box.

(FIG. E) Wired or wireless connection from connection box to smoke detection embodiment.

(FIG. F) Wired or wireless connection to the reset switch or button. To reset the embodiment to its normal operating condition providing protection from fire due to over cooking on the appliance or device it is connected to.

Incorporate a Smoke Detectors signal circuitry to remove Electrical power to a Cooking appliance such as a Stove. This will prevent most fires from occurring due to overcooking on a stove. Can be used for any conventional stove. The Fire Sentry is so easy to use because, it plugs in to the existing outlet for your Stove (Cooking Appliance) and your Stove plugs into it. This embodiment can also be portable so it can be taken on trips or with you should you relocate. This is especially helpful to those who are elderly, have alzheimer's. It can also prevent fire from, falling asleep while cooking on the stove, or any other cooking appliance that it is connected to. This embodiment is easily resettable after the cause of triggering has been removed.

1. Fire Sentry will disengage Electrical power to Cooking/Heating Devices when Black Smoke is Present. Once Black Smoke is removed Fire Sentry can be reset and normal Cooking/Heating activities can be resumed. Fire Sentry will prevent most household fires due to over cooking or over heating items on a Stove.
